(19) United States
(12) Patent Application Publication
(10) Pub. No.: US 2012/0096094 A1
(43) Pub. Date: Apr. 19, 2012

(54) APPARATUS AND METHOD FOR UPDATING E-BOOK CONTENT

(75) Inventors: Young-Wan SO, Gunpo-si (KR); Young-Sun RYU, Seongnam-si (KR); Jae-Yeon SONG, Seoul (KR)

(73) Assignee: Samsung Electronics Co., Ltd.

(21) Appl. No.: 12/971,497

(22) Filed: Dec. 17, 2010

(30) Foreign Application Priority Data
Oct. 14, 2010 (KR) 10-2010-0100237

(51) Int. Cl. G06F 15/16

(52) U.S. Cl. 709/206

(57) ABSTRACT

A method and apparatus for updating E-book content in an E-book terminal where upon a request for update of an E-book package, the E-book terminal sends an E-book content update request message including a version of the E-book package to an E-book server, receives from the E-book server an E-book content update response message including a content-specific version list or a content-specific action list included in the version of the E-book package, determines content to be updated based on the E-book content update response message, sends the E-book server a content request message for requesting the content to be updated, and updates the E-book content by receiving content of the latest version for the requested content from the E-book server.

### PRIORITY

This application claims priority under 35 U.S.C. §119(a) to a Korean Patent Application filed in the Korean Intellectual Property Office on Oct. 14, 2010 and assigned Serial No. 10-2010-0100237, the disclosure of which is incorporated herein by reference.

### BACKGROUND OF THE INVENTION

1. Field of the Invention

The present invention relates generally to Electronic Book (E-book) content, and more particularly, to an apparatus and method for updating E-book content.

2. Description of the Related Art

In line with rapid development in communication technology and computer science, E-book terminals are becoming prevalent, allowing users to read books or documents anytime and anywhere to accommodate today's busy modern lifestyles. An E-book refers to digital books that can be used like printed books by accessing recorded multimedia information such as texts and images in electronic media. E-books may be realized in any terminal, in which a user can store digital documents, including portable terminals such as Personal Digital Assistants (PDAs) and cell phones.

FIG. 1 illustrates a conventional way of purchasing E-book content, where an E-book user purchases and downloads E-book content provided by an E-book server 110 on an E-book terminal 100. When the E-book user purchases E-book content from the E-book server 110 on the E-book terminal 100 on a package basis, information in an old version or typographical errors may be included in the purchased E-book content. In this case, to correct the mistaken purchase, the user should re-purchase or re-download the whole updated content package, which is wasteful given the growing trend of high-capacity multimedia E-books.

### SUMMARY OF THE INVENTION

The present invention has been made to address at least the above problems and/or disadvantages and to provide at least the advantages described below. Accordingly, an aspect of the present invention provides an E-book content update apparatus and methods relating to partially and dynamically updating E-book content.

In accordance with one aspect of the present invention, there is provided a method for updating E-book content in an E-book terminal. The method includes, upon a request for update of an E-book package, sending an E-book content update request message including a version of the E-book package to an E-book server; receiving from the E-book server an E-book content update response message including a content-specific version list or a content-specific action list included in the version of the E-book package; determining content to be updated based on the E-book content update response message; sending the E-book server a content request message for requesting the content to be updated; and updating the E-book content by receiving content of the latest version for the requested content from the E-book server.

In accordance with another aspect of the present invention, there is provided a method for updating E-book content in an E-book server. The method includes receiving an E-book content update request message including a version of an E-book package, from an E-book terminal; sending the E-book terminal an E-book content update response message including a content-specific version list or a content-specific action list included in the version of the E-book package; receiving from the E-book terminal a content request message for requesting content to be updated according to the E-book content update response message; and delivering content of the latest version of the update requested content included in the content request message, to the E-book terminal.

In accordance with still another aspect of the present invention, there is provided an apparatus for updating E-book content in an E-book terminal. The apparatus includes an E-book content storage unit for storing an E-book package downloaded from an E-book server; a transceiver for performing communication with the E-book server; a rendering and displaying unit for rendering E-book content stored in the E-book content storage unit, and outputting the rendered E-book content to a user; and a controller for, upon a request for update of the E-book package stored in the E-book content storage unit, controlling the transceiver to send an E-book content update request message including a version of the E-book package to the E-book server, and upon receiving from the E-book server an E-book content update response message including a content-specific version list or a content-specific action list included in the version of the E-book package, controlling the transceiver to send the E-book server a content request message for requesting content to be updated based on the E-book content update response message, and controlling the rendering and displaying unit to update content of the E-book package stored in the E-book content storage unit by receiving content of the latest version for the requested content from the E-book server, to render the updated content of the E-book package, and to provide the rendered content to the user.

In accordance with yet another aspect of the present invention, there is provided an apparatus for updating E-book content in an E-book server. The apparatus includes a transceiver for receiving an E-book content update request message including a version of an E-book package, from an E-book terminal; and a controller for controlling the transceiver to send the E-book terminal an E-book content update response message including a content-specific version list or a content-specific action list included in the version of the E-book package, receiving a content request message for requesting content to be updated according to the E-book content update response message, from the E-book terminal through the transceiver, and delivering content of the latest version of the update requested content included in the content request message, to the E-book terminal through the transceiver.

### BRIEF DESCRIPTION OF THE DRAWINGS

The above and other aspects, features and advantages of the present invention will be more apparent from the following description when taken in conjunction with the accompanying drawings, in which:

FIG. 1 is a diagram illustrating the conventional method of purchasing E-book content by an E-book user according to the prior art;

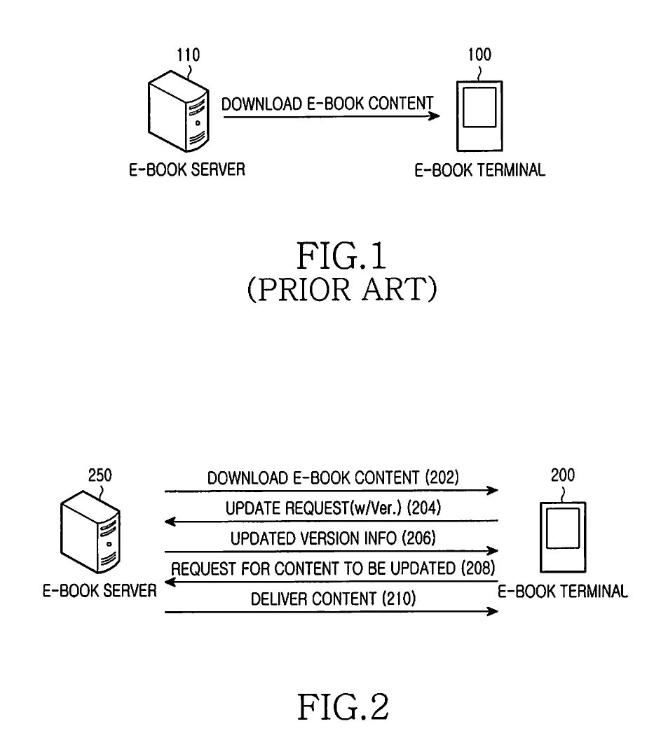

FIG. 2 is a schematic diagram illustrating an embodiment of the present invention;

FIG. 3 is a diagram illustrating a configuration of an E-book content update system according to an embodiment of the present invention;

FIG. 4 is a signal flow diagram illustrating a process of updating E-book content between an E-book server and an E-book terminal according to a first embodiment of the present invention;

FIG. 5 is a signal flow diagram illustrating a process of updating E-book content between an E-book server and an E-book terminal according to a second embodiment of the present invention; and

FIGS. 6 and 7 are signal flow diagrams between an E-book terminal and an E-book server, showing a process of dynamically updating E-book content stored in the E-book terminal according to the embodiments of the present invention.

### DETAILED DESCRIPTION OF EMBODIMENTS OF THE PRESENT INVENTION

Embodiments of the present invention are described in detail with reference to the accompanying drawings. The same or similar components, features and structures may be designated by the same or similar reference numerals. Specific details such as detailed configuration and components are merely provided to assist the overall understanding of embodiments of the present invention. Therefore, it should be apparent to those skilled in the art that various changes and modifications of the embodiments described herein can be made without departing from the scope and spirit of the invention. In addition, descriptions of functions and constructions known in the art may be omitted for clarity and conciseness.

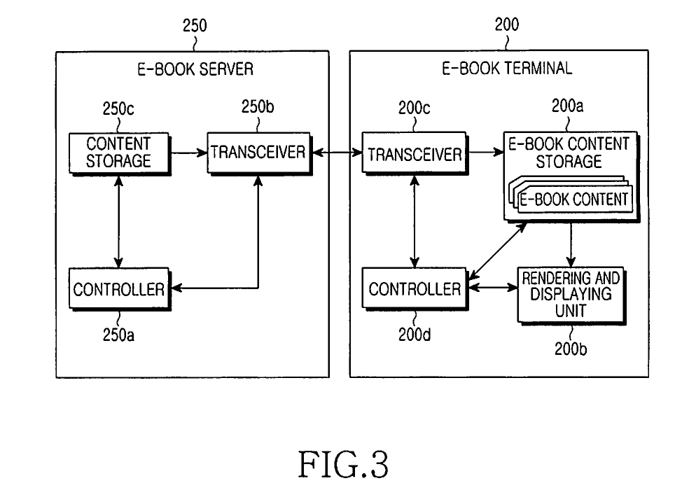

FIG. 2 is a schematic diagram illustrating an embodiment of the present invention where an E-book terminal 200, according to an embodiment of the present invention, downloads E-book content from an E-book server 250 in step 202, and sends the E-book server 250 an update request for the E-book content and its E-book version information as well in step 204. In step 206, the E-book server 250 transmits updated version information to the E-book terminal 200.

In step 208, the E-book terminal 200 sends the E-book server 250 a request for the content to be updated based on the updated version information. In step 210, the E-book server 250 delivers the content requested in step 208 by the E-book terminal 200, to the E-book terminal 200.

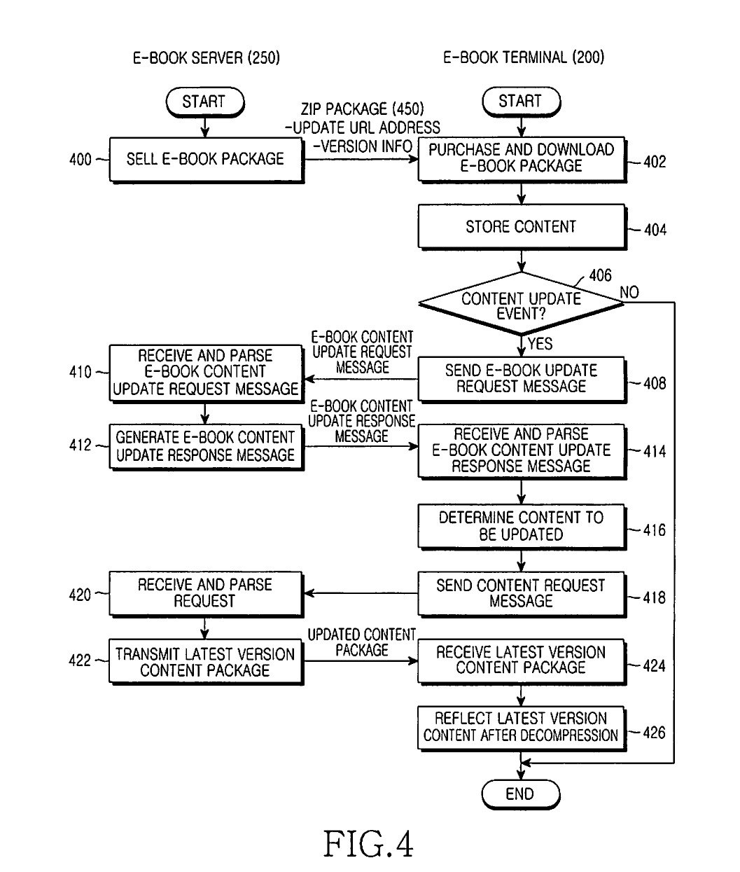

FIG. 3 illustrates a configuration of an E-book content update system according to an embodiment of the present invention which includes the E-book server 250 for providing E-book content, and the E-book terminal 200 for receiving E-book content from the E-book server 250, providing the received E-book content to a user, sending a content update request to the E-book server 250 through interaction with the user or an event occurring in a specific condition, downloading the E-book content updated in response to the update request, and providing the downloaded E-book content to the user.

The E-book server 250 includes a controller 250a, a transceiver 250b and a content storage unit 250c. The content storage unit 250c stores E-book content. The transceiver 250b exchanges E-book content and E-book content update request/response messages proposed by the present invention with E-book terminal 200 in accordance with a predetermined communication protocol. The controller 250a is adapted to provide E-book content to the E-book terminal 200, and upon receipt of an update request for the E-book content from the E-book terminal 200, to provide E-book content needed to be updated or an action related to the E-book content, to the E-book terminal 200.

According to an embodiment of the present invention, the controller 250a inserts into an E-book package at least one of Uniform Resource Location (URL) information with which the E-book terminal 200 may request E-book content-specific version information, and version information of the E-book package. The controller 250a transmits the E-book package to the E-book terminal 200 through the transceiver 250b. Upon request from the E-book terminal 200, the controller 250a transfers an E-book content-specific version list or a content-specific update action list to the E-book terminal 200 through the transceiver 250b. Upon receipt of a content request message from the E-book terminal 200, the controller 250a packages content corresponding to each update requested E-book content identification (ID) included in the content request message, and delivers the packaged content to the E-book terminal 200 through the transceiver 250b.

The E-book terminal 200 includes an E-book content storage unit 200a, a rendering and displaying unit 200b, a transceiver 200c, and a controller 200d. The E-book content storage unit 200a stores E-book content provided from the E-book server 250. The rendering and displaying unit 200b renders E-book content and visually shows the user the rendered E-book content. The transceiver 200c receives E-book content from the E-book server 250, and sends/receives messages related to the update of E-book content. The controller 200d determines whether to update E-book content depending on user request or a specific condition, and extracts update-related information, such as version information of the content subjected to update and a URL address of an E-book server capable of providing E-book content, from the E-book content stored in the E-book content storage unit 200a. The controller 200d generates an E-book content update request message using update-related information, and sends the E-book content update request message to the E-book server 250 through the transceiver 200c.

After sending the E-book content update request message, upon receiving an E-book content update response message from the E-book server 250 in response thereto, the controller 200d determines whether to update individual content according to content-specific version list information or the content-specific update action list included in the received E-book content update response message. Based on the determination, the controller 200d sends a content request message including an ID of content needed to be updated, through the transceiver 200c, and receives content corresponding to the ID of the update requested content in response to the content request. The controller 200d stores the received content of the latest version in the E-book content storage unit 200a, and controls the rendering and displaying unit 200b to render an E-book package, in which the content of the latest version stored in the E-book content storage unit 200a is reflected, and to show the user the rendered E-book package. The rendering and displaying unit 200b visually shows the user the E-book content or a variety of operation screens using Electronic ink (E-ink). If E-ink is unavailable, the rendering and displaying unit 200b may show the user the E-book content or operation screens using the existing Liquid Crystal Display (LCD), and if an input is received from the user through a touch panel mounted thereon, the rendering and displaying unit 200b may deliver the input to the controller 200d.

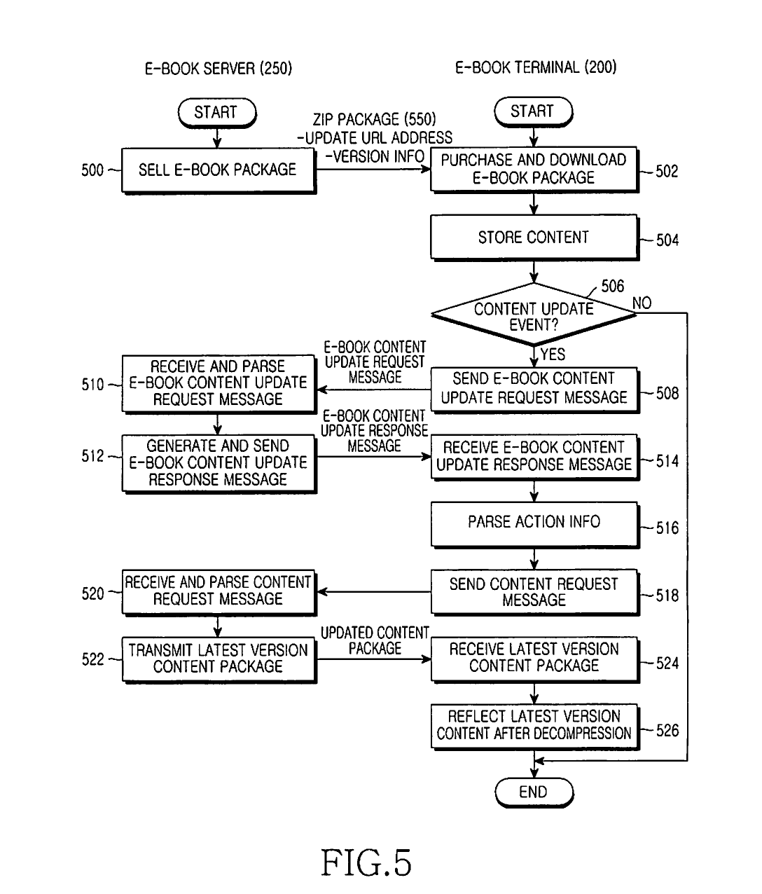

FIG. 4 illustrates a process of updating E-book content between an E-book server and an E-book terminal according to a first embodiment of the present invention, in which E-book content needed to be updated is determined by the E-book terminal or by user intervention.

The E-book server 250 sells an E-book content package in step 400, and the E-book terminal 200 purchases and stores the E-book content package on sale in step 402. The E-book content package 450 on sale in step 400 includes an update URL address, or a URL address of the E-book server 250 having the updated E-book content, and E-book content-specific version information. The E-book content package 450 may be provided in the form of a ZIP package. An example of metadata included in the E-book content package 450 and written in an Extensible Markup Language (XML) is as shown in Table 1 below, in which a format for an E-book package entitled “As You Like It” is shown according to an embodiment of the present invention. In step 404, the E-book terminal 200 stores the E-book content downloaded in step 402, and upon user request, renders the stored E-book content and displays the rendered E-book content to the user.

TABLE 1
The META-INF/container.xml file:

<?xml version=″1.0″?>
<container version=″1.0″
xmlns=″urn:oasis:names:tc:opendocument:xmlns:container″>

<rootfiles>

| <rootfile | full-path=″OEBPS/As You Like It.opf“ BookVersion=1.0.1 |
|---|---|
| | Detailed_List_URL=“http://book.server.com/update” |
| | media-type=″application/oebps-package+xml″ /> |
| <rootfile | full-path=″OEBPS/As You Like It.pdf“ BookVersion=1.4.0 |

Detailed_List_URL=“http://book.server.com/update1”
media-type=″application/pdf″ />

</rootfiles>

</container>

Referring to Table 1, a “BookVersion” field indicating a version of the E-book package, and a “Detailed_List_URL” field indicating an address of an E-book server from which the E-book terminal 200 can acquire a list of detailed version information for individual E-book content are inserted into the E-book content package 450. It is shown in Table 1 that even the same E-book content may have different version depending on whether it is created in an epub format or a PDF format, which are typical standards for E-book. The E-book package refers to a bundle of content constituting E-book, and E-book content refers to chapters, indexes, image files, audio files, etc. included in E-book.

In Table 1, a file extension “opf,” refers to an abbreviation for “Open Packaging Format,” which represents an extension of E-book based on the Electronic Publication (epub) format, while a file extension “pdf,” refers to an abbreviation for “Portable Document Format,” which represents an extension of an E-book based on the PDF format.

Like “Detailed_List_URL” in Table 1, the URL address of an E-book server may be transmitted by being inserted into E-book content, or may be provided by being included in a reader program itself installed in the E-book terminal.

If an event regarding an E-book content update request occurs in step 406, the E-book terminal 200 extracts pre-stored update-related information from E-book content and based thereon, sends an update request message in the form of an HTTP REQUEST message in step 408. As defined in Table 2 below, the update request message sent in step 408 includes a “BookVersion” field, which is version information of the E-book package presently stored in the E-book terminal 200, and a “Detailed_List_URL” field indicating a URL address of a server where the E-book content updated in Table 1 is stored.

TABLE 2

GET Detailed_List_URL ? BookVersion=1.0.1 HTTP/1.1

Table 2 above illustrates an E-book content update request message that the E-book terminal 200 sends according to an embodiment of the present invention. Table 2 illustrates that with the use of an HTTP GET command, the E-book terminal 200 informs the E-book server 250 having an address of “Detailed_List_URL” that a version of its current E-book package is 1.0.1, using an HTTP 1.1 version, and sends an E-book content update request to the E-book server 250.

Although it is assumed in the present invention that the E-book server having provided E-book content to the E-book terminal 200 is identical to the E-book server capable of providing updated E-book content, they may be different servers. Otherwise, one E-book server may have a plurality of URL addresses, and may respond to an E-book package-specific update request using each URL address.

In step 410, the E-book server 250 receives the E-book content update request message, and parses the received E-book content update request message. Further, after parsing the E-book content update request message, the E-book server 250 extracts version information of the E-book package included in the E-book content update request message, and compares it with a version of the E-book package presently stored the E-book server 250. After the version comparison, the E-book server 250 extracts its content-specific detailed latest version information of the E-book package.

In step 412, the E-book server 250 sends an E-book content update response message including E-book content-specific detailed latest version information corresponding to the latest version of the E-book package, in the form of an HTTP RESPONSE message. A format of the E-book content update response message according to the present invention is as shown in Table 3 below. The reason for sending the E-book content-specific detailed latest version information is because there is a need to inform the E-book terminal 200 of updated content-specific versions so that the E-book terminal 200 may perform update content by content, since chapters, audio files, image files and indexes, etc. which are individual content included in the E-book package, can be updated individually.

Therefore, the E-book content update response message according to the first embodiment of the present invention includes a content-specific version list shown in Table 3 below, which includes an “item id” field, an “itemver” field indicating a version corresponding thereto, and an “update_URL” field.

TABLE 3

| | |
|---|---|
| HTTP/1.1 | 200 OK |

Content Type: application/oebps-package+xml
<?xml version=″1.0″?>
<!DOCTYPE

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

</metadata>
<manifest>

<item id=″4915″ href=″book.html″ media-type=″text/x-oeb1-document“ itemver=“1.0”/>
<item id=″7184″ href=″images/cover.png″ media-type=″image/png“ itemver=“1.5.2”/>
<Update_URL> http://book.server.com/update1 </Update_URL>

| </manifest> | | |
|---|---|---|
| <spine> | <itemref idref=″4915″/> | </spine> |

</package> [symbol]
indicates data missing or illegible when filed

In Table 3, “item id” is a field for identifying individual content included in an E-book package, “itemver” is a field indicating a version of individual content included in the E-book package, and “update_URL” is a field indicating a URL address in the E-book server capable of handling a content request message.

In step 414, the E-book terminal 200 receives and parses the E-book content update response message sent by the E-book server 250. Based on the parsing in step 414, the E-book terminal 200 determines E-book content needed to be updated, in step 416. Determining the E-book content needed to be updated may be achieved by the controller 200d in the E-book terminal 200, or by the user. In the former case where the E-book terminal 200 determines to update the E-book content, its controller 200d compares each content-specific version included in the content-specific version list included in the received E-book content update response message with a pre-stored version of E-book content, and should update the content as content of the latest version, if the content version included in the content-specific version list is higher than the pre-stored version of E-book content. On the other hand, in the latter case where the user determines to update the E-book content, the user directly determines the content to be updated, considering individual content-specific version information, and inputs an action to update the determined content, to the E-book terminal 200.

In step 418, the E-book terminal 200 sends a content request message for requesting to update the content determined to be updated in step 416, to the E-book server 250 in the form of an HTTP REQUEST message. The content request message includes “item id” for identifying the E-book content to be updated. The content request message may be configured as defined in Table 4 below.

TABLE 4

GET Update_URL ? id=4915,7184 HTTP/1.1

In Table 4, “id” represents the update requested E-book content.

In step 420, the E-book server 250 receives the content request message sent by the E-book terminal 200, and identifies E-book content corresponding to “id” of the content update requested by the E-book terminal 200, by parsing the received content request message. In step 422, the E-book server 250 delivers to the E-book terminal 200 the content package or individual content including the latest version of the identified E-book content.

In step 424, the E-book terminal 200 receives the content package of the latest version, provided in step 422 by the E-book server 250. In step 426, the E-book terminal 200 decompresses the content package of the latest version, and replaces the existing content with the updated content.

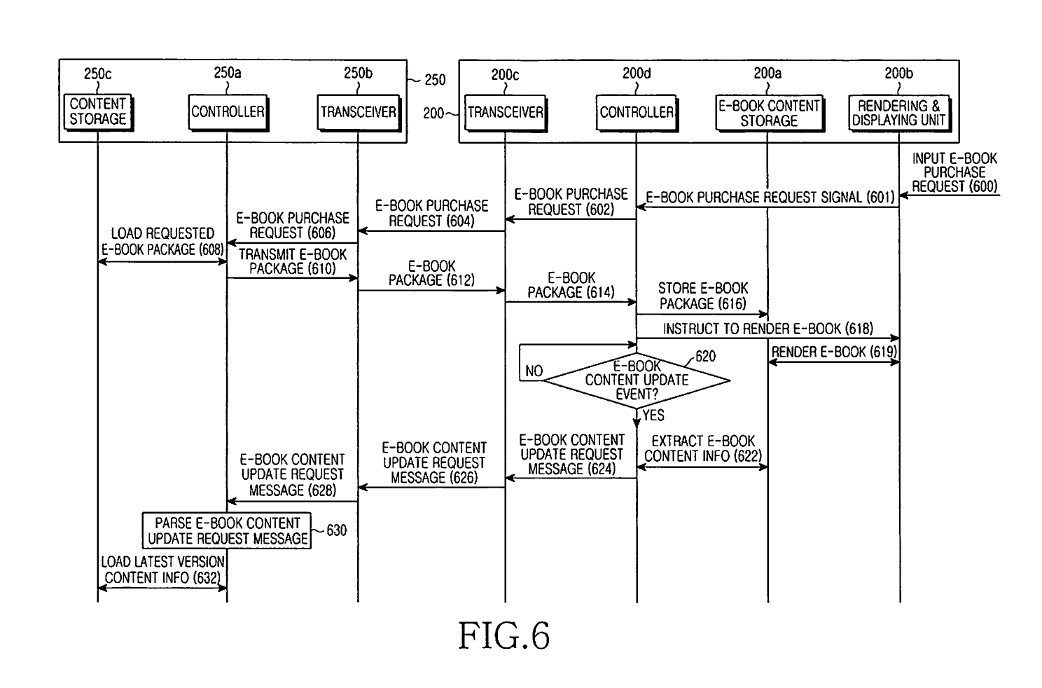

FIG. 5 illustrates a process of updating E-book content between an E-book server and an E-book terminal according to a second embodiment of the present invention, in which the E-book server determines an action for individual E-book content needed to be updated, such as ADD, REPLACE and REMOVE actions, and notifies the E-book terminal of the determined action.

Since steps 500 to 510 in FIG. 5 are equivalent to steps 400 to 410 in FIG. 4, a detailed description thereof is omitted.

In step 512, the E-book server 250 transmits a content-specific action list including a list of actions corresponding to changed content in the E-block content corresponding to a version of the E-book package 550 received in step 510, to the E-book terminal 200 using an E-book content update response message. In step 514, the E-book terminal 200 receives the E-book content update response message. The content-specific action list included in the E-book content update response message generated in step 512 includes actions corresponding to the content to be updated. The actions, instructions applied to respective content included in the E-book package, represent instructions to remove content, replace the content with other content, and add new content. The E-book content update response message according to the second embodiment of the present invention, with theses instructions included therein, is as shown in Table 5 below.

TABLE 5

| | |
|---|---|
| HTTP/1.1 | 200 OK |

Content Type: application/oebps-package+xml
<?xml version=″1.0″?>
<!DOCTYPE

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

[symbol]

</metadata>
<manifest>

<item id=″4915″ href=″book.html″ media-type=″text/x-oeb1-document“ action=“REMOVE”/>
<item id=″7184″ href=″images/cover.png″ media-type=″image/png“ action=“REPLACE”/>
<item id=“1111″ href=″images/beauty.png″ media-type=″image/png“ action=“ADD”/>
<Update_URL> http://book.server.com/update1 </Update_URL>

| </manifest> | | |
|---|---|---|
| <spine> | <itemref idref=″4915″/> | </spine> |

</package> [symbol]
indicates data missing or illegible when filed

Table 5 above illustrates a format of the E-book content update response message transmitted from the E-book server 250 to the E-book terminal 200 according to the second embodiment of the present invention, and it is created using the XML language.

In Table 5, “item id” is a field for identifying individual content included in the E-book packet, and “action” is a field indicating a control action corresponding to the content. In addition, “update_URL” represents a URL address of the server capable of handling the E-book content update request message to be updated.

In step 516, the E-book terminal 200 parses the received E-book content update response message. For example, in step 516, since for the content with “item id”=“4915,” its control action is “REMOVE” in Table 5, the E-book terminal 200 determines that it should remove the content with “item id”=“4915.” In addition, since for the content with “item id”=“7184,” its control action is “REPLACE,” the E-book terminal 200 determines that it should replace the content with “item id”=“7184.” Since for the content with “item id”=“1111,” its control action is “ADD,” the E-book terminal 200 determines that it should add the content “item id”=“1111.”

In step 518, the E-book terminal 200 sends the E-book server 250 a content request message for requesting content that corresponds to the control action=“ADD” or “REPLACE” based on the parsing in step 516. At this point, the E-book terminal 200 transmits “item id” as well, which corresponds to the content subjected to “ADD” and “REPLACE.”

After receiving the content request message, the E-book server 250 distinguishes “item id” requested by the E-book terminal 200 in step 520, and delivers a content package including E-book content corresponding to the “item id” to the E-book terminal 200 in step 522.

In step 524, the E-book terminal 200 receives the content package of the latest version provided in step 522 by the E-book server 250. In step 526, the E-book terminal 200 decompresses the content package of the latest version, and then replaces the existing content with the updated content, or adds new content according to the control action.

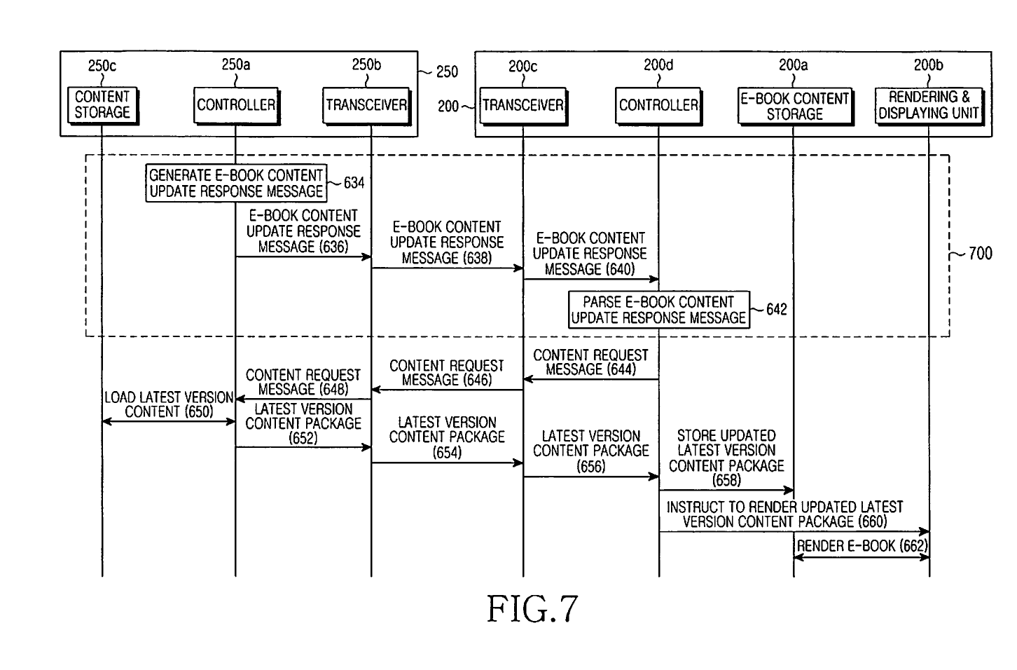

FIGS. 6 and 7 are signal flow diagrams between the E-book terminal 200 and the E-book server 250, showing a process of dynamically updating E-book content stored in the E-book terminal 200 according to an embodiment of the present invention. FIGS. 6 and 7 is one conceptual diagram separated in two figures for convenience's sake.

In FIG. 6, if the user inputs an E-book purchase request in step 600, the rendering and displaying unit 200b delivers an input E-book purchase request signal to the controller 200d in step 601. In steps 602 and 604, the controller 200d sends an E-book purchase request to the E-book server 250 via the transceiver 200c.

Upon receiving the E-book purchase request signal in step 606, the controller 250a in the E-book server 250 loads the E-book package requested by the E-book terminal 200 from the content storage unit 250c in step 608, and delivers the loaded E-book package to the E-book terminal 200 through the transceiver 250b in steps 610 and 612.

Upon receiving the E-book package in step 614, the controller 200d in the E-book terminal 200 stores the received E-book package in the E-book content storage unit 200a in step 616. In addition, in step 618, the controller 200d instructs the rendering and displaying unit 200b to render the E-book content. In step 619, the rendering and displaying unit 200b renders the E-book content stored in the E-book content storage unit 200a, and provides it to the user. If an E-book content update event has occurred in step 620, the controller 200d extracts E-book content information from the E-book content storage unit 200a in step 622. According to an embodiment of the present invention, the controller 200d may determine whether the E-book content update event has occurred or not, by checking whether a preset update period of E-book content has come, or whether an update request input is received from the user. Besides, the controller 200d may determine whether the E-book content update event has occurred, depending on a request in a specific condition. The specific condition may refer to the advent of an update period in the case where E-book content is periodically updated, or to the time the user wants to view a specific page.

After extracting the E-book content information in step 622, the controller 200d sends an update request message to the E-book server 250 via the transceiver 200c in steps 624 and 626. The controller 250a in the E-book server 250 receives the update request message through the transceiver 250b in step 628, and then parses the received update request message and extracts version information of the E-book package, included in the received update request message in step 630. This has already been described in steps 410 and 510, so its detailed description is omitted. In step 632, the controller 250a loads, from the content storage unit 250c, content information of the E-book content-specific detailed latest version corresponding to a version of the received E-book package.

Referring to FIG. 7, in step 634, the controller 250a generates an E-book content update response message as described in step 412 or 512. In the case of the first embodiment of the present invention, the controller 250a may insert the E-book content-specific detailed latest version list information into the E-book content update response message as described in step 412, and in the case of the second embodiment of the present invention, the controller 250a may insert a list of actions included in individual content included in the E-book package into the E-book content update response message as described in step 512. Thereafter, in steps 636 and 638, the controller 250a sends the generated E-book content update response message to the E-book terminal 200 through the transceiver 250b.

The controller 200d in the E-book terminal 200 receives the E-book content update response message through the transceiver 200c in step 640, and parses the received E-book content update response message in step 642. Step 642 corresponds to steps 414 and 416 in FIG. 4 in the case of the first embodiment, and to step 516 in FIG. 5 in the case of the second embodiment of the present invention.

In steps 644 and 646, the controller 200d sends a content request message for requesting the content needed to be updated, to the E-book server 250 through the transceiver 200c based on the parsing in step 642.

The controller 250a in the E-book server 250 receives the content request message through the transceiver 250b in step 648, and loads the latest version of the content corresponding to a content ID included in the content request message from the content storage unit 250c in step 650. In steps 652 and 654, the controller 250a delivers the loaded content package of the latest version to the E-book terminal 200 through the transceiver 250b.

The controller 200d in the E-book terminal 200 receives the content package of the latest version through the transceiver 200c in step 656, and stores content of the latest version included in the content package of the latest version in the E-book content storage unit 200a in step 658. In step 660, the controller 200d instructs the rendering and displaying unit 200b to render the updated content of the latest version. In step 662, the rendering and displaying unit 200b renders the updated content of the latest version extracted from the E-book content storage unit 200a and provides it to the user. The operation in steps 634 through 642, represented by reference numeral 700 in FIG. 7, will be described in more detail below, separately for the first and second embodiments of the present invention.

In the first embodiment of the present invention, the controller 250a in the E-book server 250 generates an E-book content update response message including a content-specific version list in step 634, and sends the generated E-book content update response message to the E-book terminal 200 in steps 636 and 638. In step 642, the controller 200d in the E-book terminal 200 checks the content-specific version list included in the E-book content update response message, and compares it with content-specific version information checked in step 622 by the E-book content storage unit 200a. After the comparison, the controller 200d determines to request update of any content whose latest version is higher than the content-specific version checked in step 622 among the content included in the content-specific version list, and transmits ID of the determined content along with the content request message in step 644.

In the second embodiment of the present invention, the controller 250a in the E-book server 250 generates an E-book content update response message including a content-specific action list in step 634, and sends the generated E-book content update response message to the E-book terminal 200 through the transceiver 250b in steps 636 and 638. The controller 200d in the E-book terminal 200 checks the content-specific action list included in the E-book content update response message in step 642, and transmits ID of content with action=ADD or REPLACE among the content corresponding to the content-specific action list, along with the content request message in step 644.

In actual application of the embodiments of the present invention, if the user finds typographical errors or any other errors and inputs an update request while viewing the purchased E-book content on the E-book terminal, the E-book terminal may download a revision of the latest version of the E-book content from the server providing the E-book content and provide it to the user.

While the invention has been shown and described with reference to certain embodiments thereof, it will be understood by those skilled in the art that various changes in form and detail may be made therein without departing from the spirit and scope of the invention as defined by the appended claims and their equivalents.

What is claimed is:

1. A method for updating E-book content in an E-book terminal, comprising:
upon a request for update of an E-book package, sending an E-book content update request message including a version of the E-book package to an E-book server;
receiving from the E-book server an E-book content update response message including a content-specific version list or a content-specific action list included in the version of the E-book package;
determining content to be updated based on the E-book content update response message;
sending the E-book server a content request message for requesting the content to be updated based on the determined content; and
updating the E-book content by receiving content of the latest version for the requested content from the E-book server.

2. The method of claim 1, wherein the content request message for requesting the content to be updated includes an identifier of the content determined to be updated.

3. The method of claim 1, wherein the content-specific version list includes at least one of an “item id” field for identifying individual content included in the E-book package, an “itemver” field indicating a version of individual content included in the E-book package, and an “update_URL” field indicating a Uniform Resource Location (URL) address in an E-book server capable of handling the content request message for requesting content to be updated.

4. The method of claim 3, wherein determining content to be updated based on the E-book content update response message comprises comparing each content-specific version included in the content-specific version list with a pre-stored version of E-book content if the content-specific version list is included in the E-book update response message, and determining to update the content as content of the latest version if a content version included in the content-specific version list is higher than the pre-stored version of E-book content.

5. The method of claim 1, wherein the content-specific action list includes at least one of an “item id” field for identifying individual content included in the E-book package, an “action” field indicating a control action corresponding to content with the “item id,” and an “Update_URL” field indicating a URL address in an E-book server capable of handling the content request message for requesting content to be updated.

6. The method of claim 5, wherein the control action corresponding to content comprises executing any one of ADD, REMOVE and REPLACE actions for the content corresponding to the “item id.”

7. The method of claim 6, wherein determining content to be updated based on the E-book content update response message comprises:
checking a control action included in the content-specific action list if the content-specific action list is included in the E-book update response message; and
determining to update content corresponding to ADD and REPLACE control actions among the control actions corresponding to content.

8. A method for updating E-book content in an E-book server, comprising:
receiving an E-book content update request message including a version of an E-book package, from an E-book terminal;
sending the E-book terminal an E-book content update response message including a content-specific version list or a content-specific action list included in the version of the E-book package;
receiving from the E-book terminal a content request message for requesting content to be updated according to the E-book content update response message; and
delivering content of the latest version of the update requested content included in the content request message, to the E-book terminal.

9. The method of claim 8, wherein the content request message for requesting content to be updated includes an identifier of the content to be updated.

10. The method of claim 8, wherein the content-specific version list includes at least one of an “item id” field for identifying individual content included in the E-book package, an “itemver” field indicating a version of individual content included in the E-book package, and an “update_URL” field indicating a Uniform Resource Location (URL) address in an E-book server capable of handling the content request message for requesting content to be updated.

11. The method of claim 8, wherein the content-specific action list includes at least one of an “item id” field for identifying individual content included in the E-book package, an “action” field indicating a control action corresponding to content with the “item id,” and an “Update_URL” field indicating a URL address in an E-book server capable of handling the content request message for requesting content to be updated.

12. The method of claim 11, wherein the control action corresponding to content comprises executing any one of ADD, REMOVE and REPLACE actions for the content corresponding to the “item id.”

13. The method of claim 12, wherein the update requested content includes content whose control action corresponds to the ADD or REPLACE action.

14. An apparatus for updating E-book content in an E-book terminal, comprising:
an E-book content storage unit for storing an E-book package downloaded from an E-book server;
a transceiver for performing communication with the E-book server;
a rendering and displaying unit for rendering E-book content stored in the E-book content storage unit, and outputting the rendered E-book content to a user; and
a controller for, upon a request for update of the E-book package stored in the E-book content storage unit, controlling the transceiver to send an E-book content update request message including a version of the E-book package to the E-book server, and upon receiving from the E-book server an E-book content update response message including a content-specific version list or a content-specific action list included in the version of the E-book package, controlling the transceiver to send the E-book server a content request message for requesting content to be updated based on the E-book content update response message, and controlling the rendering and displaying unit to update content of the E-book package stored in the E-book content storage unit by receiving content of the latest version for the requested content from the E-book server, to render the updated content of the E-book package, and to provide the rendered content to the user.

15. The apparatus of claim 14, wherein the content request message for requesting content to be updated includes an identifier of the content determined to be updated.

16. The apparatus of claim 14, wherein the content-specific version list includes at least one of an “item id” field for identifying individual content included in the E-book package, an “itemver” field indicating a version of individual content included in the E-book package, and an “update_URL” field indicating a Uniform Resource Location (URL) address in an E-book server capable of handling the content request message for requesting content to be updated.

17. The apparatus of claim 16, wherein the controller compares each content-specific version included in the content-specific version list with a pre-stored version of E-book content if the content-specific version list is included in the E-book update response message, and determines to update the content as content of the latest version if a content version included in the content-specific version list is higher than the pre-stored version of E-book content.

18. The apparatus of claim 14, wherein the content-specific action list includes at least one of an “item id” field for identifying individual content included in the E-book package, an “action” field indicating a control action corresponding to content with the “item id,” and an “Update_URL” field indicating a URL address in an E-book server capable of handling the content request message for requesting content to be updated.

19. The apparatus of claim 18, wherein the control action corresponding to content comprises executing any one of ADD, REMOVE and REPLACE actions for the content corresponding to the “item id.”

20. The apparatus of claim 19, wherein the controller checks a control action included in the content-specific action list if the content-specific action list is included in the E-book update response message, and determines to update content corresponding to ADD and REPLACE control actions among the control actions corresponding to content.

21. An apparatus for updating E-book content in an E-book server, comprising:
a transceiver for receiving an E-book content update request message including a version of an E-book package, from an E-book terminal; and
a controller for controlling the transceiver to send the E-book terminal an E-book content update response message including a content-specific version list or a content-specific action list included in the version of the E-book package, receiving a content request message for requesting content to be updated according to the E-book content update response message, from the E-book terminal through the transceiver, and delivering content of the latest version of the update requested content included in the content request message, to the E-book terminal through the transceiver.

22. The apparatus of claim 21, wherein the content request message for requesting content to be updated includes an identifier of the content to be updated.

23. The apparatus of claim 21, wherein the content-specific version list includes at least one of an “item id” field for identifying individual content included in the E-book package, an “itemver” field indicating a version of individual content included in the E-book package, and an “update_URL” field indicating a Uniform Resource Location (URL) address in an E-book server capable of handling the content request message for requesting content to be updated.

24. The apparatus of claim 21, wherein the content-specific action list includes at least one of an “item id” field for identifying individual content included in the E-book package, an “action” field indicating a control action corresponding to content with the “item id,” and an “Update_URL” field indicating a URL address in an E-book server capable of handling the content request message for requesting content to be updated.

25. The apparatus of claim 24, wherein the control action comprises executing any one of ADD, REMOVE and REPLACE actions for the content corresponding to the “item id.”

26. The apparatus of claim 25, wherein the update requested content includes content whose control action corresponds to the ADD or REPLACE action.
